(19) United States
(12) Patent Application Publication
(10) Pub. No.: US 2023/0017230 A1
(43) Pub. Date: Jan. 19, 2023

(54) Method for Gas Phase Alloy Enhancement of Solid State Welds

(71) Applicant: Spinduction Weld Inc., Calgary (CA)

(72) Inventor: David Grant Lingnau, Calgary (CA)

(73) Assignee: Spinduction Weld Inc., Calgary, AB (CA)

(21) Appl. No.: 17/782,950

(22) PCT Filed: Dec. 10, 2020
(86) PCT No.: PCT/CA2020/051706

§ 371 Date: Jun. 6, 2022

Related U.S. Application Data
(60) Provisional application No. 62/945,943, filed on Dec. 10, 2019.

(51) Int. Cl. B23K 13/01; B23K 13/06; B23K 20/12

(52) U.S. Cl. CPC B23K 13/015; B23K 13/06; B23K 20/12; B23K 2101/06

(57) ABSTRACT

An apparatus and method of alloying a weld in an induction-kinetic welding of metal parts together includes heating substantially planar portions of two metal parts with an induction heating coil in between the planar portions. During at least a portion of the step of heating the planar portions, flowing a gas containing an alloying element in proximity to the planar portions. A chemical reaction results in an alloying element alloying the planar portions. The induction heating coil is withdrawn from in between the planar portions and the parts are forced into contact with each other in a kinetic energy welding process resulting in the metal parts being welded together. The welded parts have improved strength in the area of the weld. The welding process can be used to increase the presence of alloying transition metals and to improve the flowability and weldability during the kinetic phase before dilution of enriched carbon by shear accelerated diffusion.

### RELATED APPLICATIONS

This application claims priority to and the benefit of U.S. Provisional Patent Application No. 62/945,943, filed on Dec. 10, 2019, the entire contents of which are hereby incorporated by reference.

### TECHNICAL FIELD

The present invention relates to enhancing the metallurgical composition, microstructure, and physical performance of rapid, solid state welds of metals and alloys. More particularly, the invention relates to enhancing the metallurgical composition, microstructure and physical performance of welds in an induction-kinetic welding process.

### BACKGROUND

A good example of highly optimized manufacture of a basic shape is the pipe used for pipelines. Starting with the chemistry, it is carefully formulated to ensure good weldability by arc welding processes. Once the best composition is decided, it is tightly controlled to ensure the end product is of high purity and consistency (e.g. homogeneous microstructure). For example, by keeping the carbon content below 0.2% and the carbon equivalent below 0.4%, the weldability is improved. If the carbon equivalent is set low, then the required strengthening can be achieved by other means such as microalloying with niobium, vanadium, etc. or by thermomechanical controlled forming processes (“TMCP”) during shaping of the final product. Especially in the case of elongated products like pipe, there is both a motivation and an inherent tendency to develop anisotropic properties in the structure where, for example the toughness is greatest in the longitudinal direction due to elongation of the microstructure along that axis during the forming process. But with that, there is a tradeoff in the transverse and/or through thickness toughness. Overall, this is beneficial for end uses such as pipelines where it is generally more important to achieve greatest strength and toughness parallel to the longitudinal axis as opposed to the through-thickness axis. Directionally tuned properties like these are manageable when conventional arc welding is used to join pieces together because the filler metals used can readily be overmatched in their composition, using increased amounts of expensive alloying elements to help compensate for any loss of strength in the immediately adjacent melt pool right up to the fusion line. Carefully designed thermal cycles in the welding procedure also can help minimize degradation of properties beyond the fusion line, such as in the various Heat Affected Zones (“HAZ”).

Over the past half century, the chemistry and performance of pipeline steels and filler metals and welding procedures have evolved together to deliver very high properties in terms of yield strength and impact toughness. Even so, there are several intrinsic disadvantages with arc welding methods which cannot be eliminated. All arc welding processes involve melting of the parent metal, therefore a whole family of phase change related weld defects are possible and probable, such as porosity, inclusions, undercut, solidification cracking, etc. Also, all commercially practical arc welding processes are incremental, multipass processes which are slow, labor intensive and much more prone to defects than solid state processes which inherently are fully automated. Recently there has been increasing interest in fully automated high speed welding processes and particularly solid state welding processes which do not involve any filler metal, technically classified as “autogenous” welding. Much research and pre-commercial development work has been done in the past decade to optimize several solid-state welding processes for critical applications and capture the many economic and technical advantages made possible by these processes. One area where these autogenous welding processes have room for improvement is increasing the bond zone properties to more closely match the anisotropically enhanced levels of the parent metal. It may never be possible to fully match the longitudinal properties of these directionally optimized products, but improvement is always desirable. Arc welding processes have had nearly a century to accomplish this, greatly aided by the resources and funding of the massive industry which has grown up around the many variants of arc welding, whereas solid state processes like Induction-Kinetic Welding (“IKW”) are much more in the infancy stage of adoption.

When solid state welding like IKW is used to join metal parts with directionally preferential properties, there is an unavoidable re-shaping and re-alignment of the microstructure. This is the result of forging displacements and/or elevated temperatures. During the IKW process, the elongated microstructure along the length axis of pipe tends to become shortened and more equi-axed. In the extreme case of Friction Welding (“FRW”) the resulting microstructure gets completely re-directed into a flattened cross axis orientation, creating what amounts to a metallurgical notch, which is centered on the bond plane. Therefore, improved IKW processes are desirable and in demand for many different applications, including but not limited to pipes for pipelines. For example, some other ideal IKW applications are the manufacture of drill pipe, downhole oilfield tools, diesel pistons, drive shafts, high pressure valve bodies, etc.

### SUMMARY

The present invention relates to enhancing the metallurgical composition and/or microstructure and physical performance of rapid, solid state welds of metals and alloys used in a wide range of industries, for example, aerospace, automotive, mining, nuclear, oil and gas, pipelines, etc. In these industries, there is increasing use of high-performance alloys, mainly steels but also including titanium alloys or nickel based alloys, which have been manufactured in basic shapes such as tubes, which in turn must often be welded together or to other components. Carefully optimized manufacturing processes for these basic shapes to achieve the highest possible performance are nearly always degraded by welding processes. It is the purpose of this invention to provide a way to reduce or eliminate that degradation from the welding process.

It is the primary objective and advantage of this invention to improve the bond zone properties of welds which are made using the rapid solid-state IKW process referred to in this disclosure, previously taught in U.S. Pat. No. 6,637,642, which is incorporated herein by reference as if repeated word for word, as well as welds made by other compatible processes. Said process utilizes induction heating of the pipe ends in a non-reactive atmosphere, quickly raising the endfaces up to the hot working temperature, which then are kinetically welded in a single rapid action of a few seconds duration, joining the entire weld cross section all in unison. This IKW process will serve as the primary example application of the present invention.

The method of the invention includes alloying a weld in an induction-kinetic welding of metal parts together, by heating substantially planar portions of two metal parts with an induction heating coil in between the planar portions. During at least a portion of the step of heating the planar portions, flowing a gas containing a fluidized finely divided alloying element or gaseous element precursor in proximity to the planar portions, wherein in a chemical reaction an alloying element alloys the planar portions. Next, retracting the induction heating coil from in between the planar portions and forcing the planar portions into contact with each other and moving at least one of the two metal parts in a kinetic energy welding process wherein the metal parts are welded together.

In another embodiment of the method of alloying a weld in an induction-kinetic welding of metal parts together, the method includes heating substantially planar portions of two metal parts with an induction heating coil in between the planar portions. During at least a portion of the step of heating the planar portions, flowing a reducing gas in proximity to the planar portions and flowing a gas containing an alloying element in proximity to the planar portions, wherein the alloying element is deposited on the planar portions. Next, retracting the induction heating coil from in between the planar portions and forcing the planar portions into contact with each other and moving at least one of the two metal parts in a kinetic energy welding process wherein the metal parts are welded together.

Another embodiment of the invention includes a method of increasing the flowability and weldability of an induction-kinetic welding of metal parts together using an alloying element, the method including heating substantially planar portions of two metal parts with an induction heating coil in between the planar portions. During at least a portion of the step of heating the planar portions, flowing a gas comprising about argon and methane in proximity to the planar portions. Next, retracting the induction heating coil from in between the planar portions and forcing the planar portions into contact with each other and moving at least one of the two metal parts in a kinetic energy welding process wherein the metal parts are welded together, wherein the methane gas reacts with planar portions, wherein during the kinetic energy welding process an instantaneous amplified shear rate is present before dilution of enriched carbon by shear accelerated diffusion occurs. This results in increased process robustness and increased bond plane strength, both of which are especially beneficial in the manufacture of steel pistons where the improved process robustness can increase the manufacturing yield. Other embodiments of the invention are included throughout this disclosure including, methods and apparatuses for performing the invention.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is graph displaying an Induction-Kinetic Weld Temperature Profile which has been modified to include an extended duration that the endfaces are held at the hot forging temperature by the induction coil, prior to retraction;

FIG. 2 is a schematic-type diagram of an induction coil apparatus of the invention;

FIG. 2A is a cross section along the lines 2B-2B of FIG. 2A;

FIG. 3 is a schematic-type diagram of an alternative embodiment of the invention;

FIG. 3A is a cross section along the lines 3A-3A of FIG. 3A;

FIG. 4 is an iron-carbon phase diagram;

FIG. 5 is a graph displaying a conventional IKW process;

FIG. 6 is a graph displaying a modified IKW process of the invention; and

FIG. 7 is a flowchart of a method of the invention.

### DETAILED DESCRIPTION

IKW is unusual among solid state processes in that it affords an ideal opportunity to introduce alloying elements into the bond plane during the weld cycle. This is a result of the IKW process consisting of two distinct steps, the first being the induction heating step and the second being the kinetic forging step which together completely avoid the waste and ejection of metal, inherent with all inertia welding processes. In most commercial applications of the IKW process, the induction heating is performed by an induction coil located in a small gap between the two opposing endfaces which are ready to be welded. Therefore, during the induction heating step, which typically ranges from 5 to 15 seconds duration, there is an ideal opportunity to introduce alloy enhancing elements onto either or both of the endfaces by metering them into the flow of the purge gas. To increase the time available for the surface alloying, it is also practical to increase the induction heating duration by bringing the endfaces up to the typical welding temperature and reducing the induction power to a holding level which extends the time at temperature for slower alloying reactions to complete.

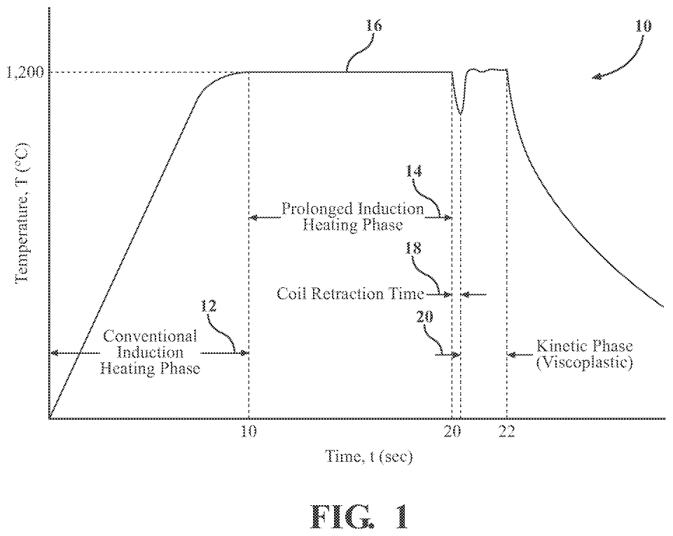

Referring to FIG. 1, as part of the process of the invention 10, in an IKW process the typical induction heating time 12 of ten (10) seconds is doubled for a prolonged induction heating phase 14. This more than triples the time at temperature 16 above about 800° C. which is the region where several important alloying reactions can begin to happen. Alloy enhancing elements such as carbon, nickel, molybdenum, niobium, vanadium, cobalt, and other metals mainly metals from the Transition Metals group of the Periodic Table are desirable additions to improve bondplane properties such as impact toughness, yield strength, hardness, etc. Carbon is the simplest element to introduce in the shielding gas since it exists in many gaseous compounds such as methane, ethane, ethylene, acetylene, propane and so on. Nickel is available a gaseous compound known as nickel carbonyl which readily decomposes on hot surfaces to deposit metallic nickel, seemingly making it ideal for this process. However, nickel carbonyl is highly toxic and not likely to be acceptable in the welding industry. Therefore, the safest and/or most practical way to introduce nickel and the other above cited metallic elements is in the form of very finely divided particles (or even nanoparticles) suspended in a carrier gas such as argon. An extended reaction time can range from seconds to minutes depending on the reaction rate of the given alloying addition. During the coil retraction time 18, it would also be possible to introduce alloy enhancing elements, but this is a very brief timespan, usually less than half a second and is accompanied by turbulence due to the rapid coil retraction, so repeatability and uniformity would be difficult to achieve. Once the induction heated surfaces have been brought into contact with each other at the start of the kinetic phase 20, there is no further opportunity to introduce alloying elements into the bond zone of the weld.

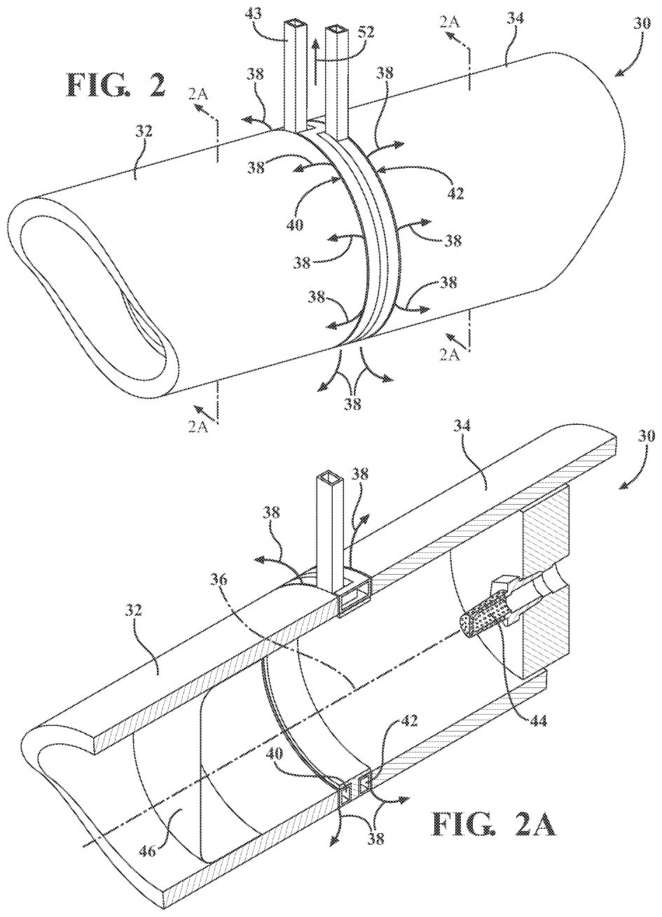

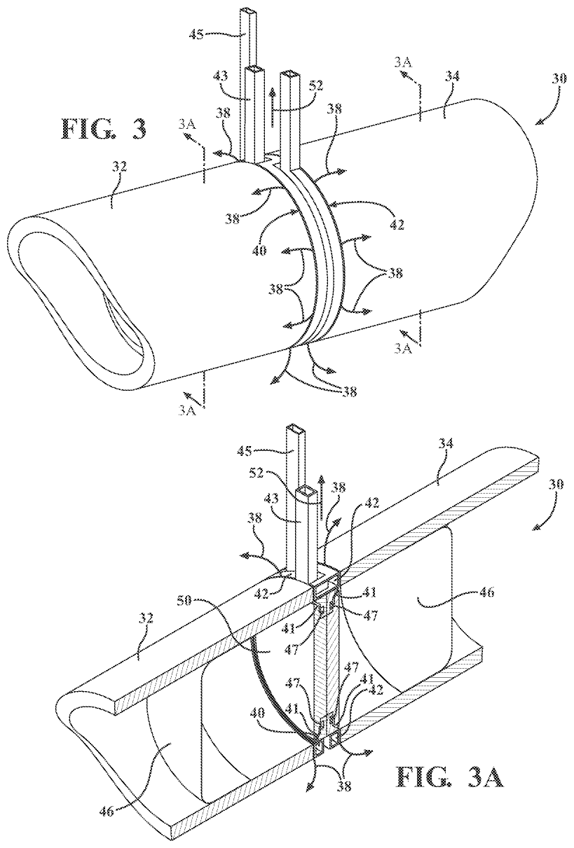

With added reference to FIGS. 2, 2A, 3 and 3A, in most commercial applications using the IKW process according to the invention 30 in the welding together of a first pipe 32 and second pipe 34, the purge gas flow direction originates from around the center axis 36, flowing radially outward 38 across a first endface 40 and a second endface 42 to be welded, finally exhausting into the surrounding atmosphere through controlled openings 38 in the outer periphery of the welding chamber proximate to an induction coil 43. This is achieved by initiating the gas flow from either:
A diffused laminar flow head 44, for example, a sintered bronze porous cone centered on the longitudinal axis on either or both sides of the bond plane, as shown with reference to FIGS. 2 and 2A, including a purge dam 46 opposite the flow head 44, or
A circular array of gas feeding pinhole ports 41 and/or ring-slot diffusors adjacent to the internal diameter (ID) edge of the induction coil 43 on one or both sides of the induction coil assembly 50 as shown in reference to FIG. 3 and include purge dams 46 on both sides. The pinhole ports 41 are fed a gas through a gas feed inlet 45 in communication with a circumferential plenum 47 in the induction coil assembly 50.

IKW machines can use either of the above methods to originate the purge gas flow and eliminate potential stagnant zones. Both are effective and controllable origins to introduce gas-entrained alloying elements into the welds. Purge dams of many different types are used to reduce the volume surrounding induction coil, making it faster and easier to achieve the required purge purity.

In the IKW process, prolonged induction heating 14 by the induction coil 43 is performed while flowing an alloying element such as an alloying gas though the flow head 44, in the embodiment of FIGS. 2 and 2A, or through the induction coil assembly 50, in the embodiment of FIGS. 3 and 3A, at least until the induction coil 43 is rapidly removed away 52 and the kinetic phase of welding the first endface 40 with the second endface 42 begins. While FIGS. 2, 2A, 3 and 3A are directed to the welding of pipes, it should be appreciated that the same processes and apparatuses could be used with other parts to be welded together where the parts include a substantially flat area suitable for the IKW process. The induction coil 43 and induction coil assembly 50 can be sized appropriately to accommodate small or large parts and to direct the gasses over a wider area of the surfaces to be welded together.

The simplest example of this gas phase alloying is carbon addition to steel. There are many potential sources of carbon in a gas phase. Historically, in the gas carburizing of steel, it is commonplace to use carbon monoxide (CO) in combination with hydrogen and methane (CH₄) to overcome the adverse effects of moisture (H₂O) unavoidably present in large furnace operations. A typical carrier gas composition for furnace carburizing is 15-25% CO, 35-45% H₂, 12% CH₄, and a balance of N₂. Clearly, this is an explosive mixture if combined with air. Since the IKW process happens in a small chamber, it is easy to assure a moisture free atmosphere by using dry purge gas, such as nitrogen or argon. Therefore, the carburizing of the induction heated surface in the IKW welding chamber can easily be accomplished without involving hydrogen gas which has a very wide explosive composition range, or carbon monoxide which is highly toxic. Instead, a single reagent such as methane works very effectively, as shown in Equation 1, below:

3Fe+CH₄→2Fe₃C+2H₂ Equation 1(“Eq. 1”):

In the presence of iron, the reaction of Eq. 1 begins at about 700° C. as an iron-catalyzed decomposition and continues at increased rates up to about 900° C. From about 1000° C. and higher, the decomposition occurs by way of a simple pyrolysis reaction. Either way, the reaction will deposit elemental carbon onto the hot surface such as the first and second endfaces 40, 42 which is causing the methane decomposition.

It has been empirically confirmed that in the typical IKW cycle with a typical induction heating phase of 5 to 15 seconds, that there is sufficient time at temperature for gas mixtures containing less than 10% methane to deposit sufficient carbon onto the enfaces 40, 42 to measurably affect the viscoplastic flow behavior during the kinetic phase of the IKW process. It is also sufficient to affect the metallurgical characteristics and physical properties in the bond zone of the completed weld which will be revisited later. Industry organizations such as the Compressed Gas Association (“CGA”) publish data on the safety of potentially combustible gas mixtures. The CGA's Standard for Categorizing Gas Mixtures Containing Flammable and Nonflammable Components (CGA-P23, 4^{th} Edition) states that methane-argon mixtures containing less than 10% methane are non-combustible when mixed with any proportion of air. Therefore, the present invention works very well with methane-argon mixtures which are neither explosive nor toxic.

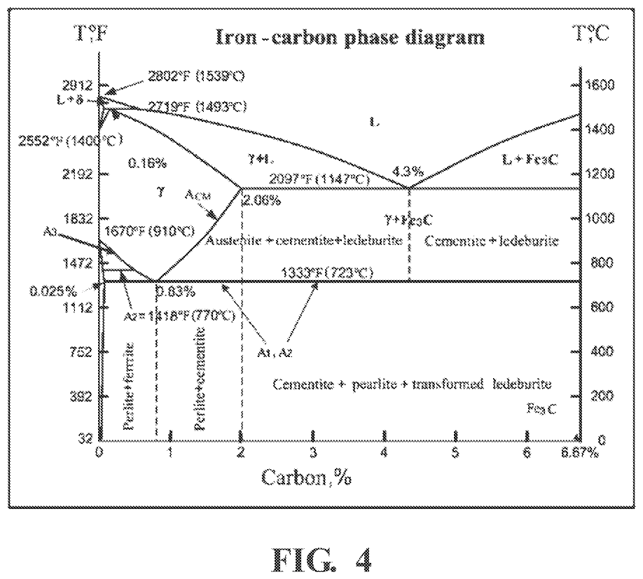

Referring to FIG. 4, a standard iron-carbon phase diagram by Dr. Dmitri Kopeliovich (from www.substech.com) helps to understand why enriched carbon on the hot weld face affects the viscoplastic flow during the IKW process. Starting at the extreme left end of the abscissa, it is seen that carbon reduces the liquidus of pure iron from 1539° C. (2802° F.) down to 1493° C. (2720° F.) for steel containing 0.50% carbon. Further increases of the carbon content reduces the liquidus down to the eutectic minimum of 1130° C. (2066° F.) at 4.3% carbon. Increasing the carbon content above 4.3% reverses the trend and begins to increase the liquidus temperature. In terms of typical IKW parameters, this localized reduction of the liquidus by hundreds of degrees has profound effects on the viscoplastic flow behavior during the starting instant of the kinetic phase of the IKW process.

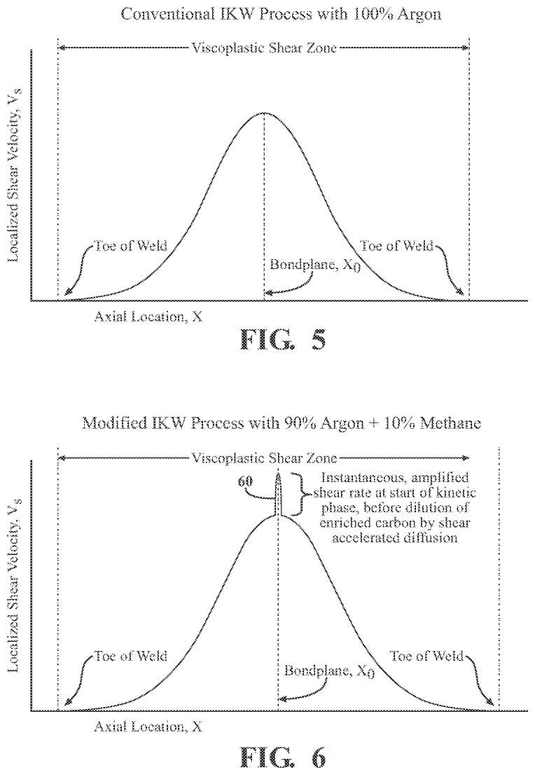

Now referring to FIG. 5, the shear velocity in the IKW process closely resembles a normal Gaussian distribution with the peak velocity occurring at the bondplane of the endfaces 40, 42. However, it is well known to those skilled in the art of IKW that there is normally no slippage at the bond plane, and therefore the shear velocity profile has a round top with a large stable horizontal tangent.

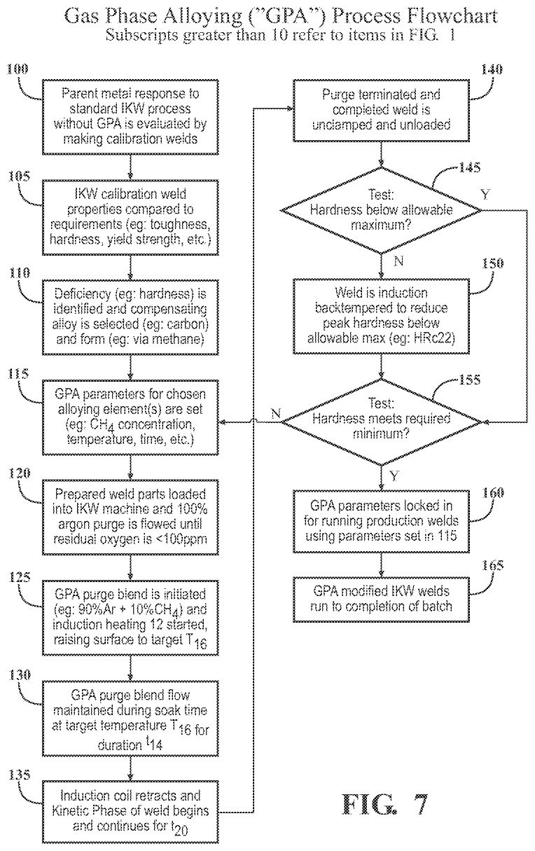

Referring to FIG. 6, shows what happens to the shear velocity profile when the mating surfaces of the endfaces 40, 42 in the IKW process are enriched with carbon, due to depression of the liquidus within a very shallow surface layer. For an optimized concentration and depth of carbon enrichment, the centerline spike 60 in shear velocity is greatest at commencement of the kinetic phase and then diminishes due to accelerated diffusion and dilution through the duration of the kinetic phase.

It is well known that most practical applications for welding of steels would require limiting the carbon concentration below 0.5% at any location in the completed weld. Due to the controllable time available for diffusion during the induction heating phase and the accelerated diffusion which happens during the kinetic phase, it is both possible and practical to temporarily create a high surface concentration of carbon, well above 0.5% yet produce welds in which the final concentration at the bond plane is much lower. During the induction phase, the achievable surface concentration of carbon is infinitely variable and easily controlled between 0.0% and 4.3%, especially if different hydrocarbon gases are used, such as ethylene or acetylene. Once the kinetic phase begins, any further deposition of carbon is precluded because the surfaces are now in contact and gas flow over the hot endfaces is terminated. Most importantly, the carbon enriched surface layer of the two mating surfaces are exactly in the center of the peak of the shear gradient which typically happens in the IKW process. It has been shown empirically that having a lower viscosity interface in the center of the IKW shear zone accelerates bonding and improves coalescence of the two opposed surfaces into a fully welded interface. This increases the robustness of the IKW process, reducing the probability of defects, which would otherwise occur due to misalignment of the weld faces and/or imperfections in the recommended planar weld face preparation. Also, certain microstructures of steels can be very sensitive to shear rates and/or shear amplitude, for example cast 4140 steel which is commonly used in steel pistons. Having a more flowable and shear tolerant surface layer at the start of the weld cycle can increase the process robustness for such steels. Speed of the enrichment reaction can be increased by switching from methane to more reactive hydrocarbon gases such as ethylene or acetylene, according to these equations:

6Fe+C₂H₄→2Fe₃C+2H₂ Equation 2:

6Fe+C₂H₂→2Fe₃C+H₂ Equation 3:

The probability of hydrogen penetration into the steel is also lower for ethylene versus methane and further so for acetylene versus ethylene.

For steel alloys and with a properly selected enrichment level of carbon, one of the other benefits of the present invention is increasing the toughness at the bondplane.

Once an IKW system has been equipped to meter controlled amounts of hydrocarbon gas into the purge atmosphere, it then becomes possible and practical to introduce other alloying elements. For example, nickel, molybdenum, niobium, vanadium and certain other elements have known beneficial effects on toughness and/or strength of steel. Nanoparticles of pure metals suspended in liquid are commercially available. So, to those skilled in the art, it is both possible and practical to transfer nanoparticles of these elements into an inert gas stream by using thermal vaporization or ultrasonic vaporization, for example.

The present invention also applies to all other metals and alloys amenable to the IKW process, for example titanium alloys and stainless steel alloys and nickel based alloys as well as zirconium and hafnium based alloys.

Referring to FIG. 7 a simplified flowchart of a typical Gas Phase Alloying application is provided. Before deciding which of the many possible alloy additions to use in any particular application, it is advisable to first determine the native properties of the parent metal intended to be welded in the standard IKW process with just 100% pure argon as the shielding gas. This is shown as the first step 100 and considered to be a “calibration weld.” Even as a calibration weld, there are many options in the IKW process with respect to what peak temperature is targeted, what shear velocity is used, what total amount of shear displacement is used. Therefore, the parameters used in the calibration weld are heavily based on prior experience with the general if not specific chemistry and of the metal being welded.

Once a calibration weld has been run, it can be tested by such methods 105 as Charpy impact testing, Vickers hardness testing, tensile testing to learn the basic physical properties of the weld. With this information, an engineering assessment can be made whether there are any particular properties which are deficient with respect to what is required by welding code and/or customer specifications 110. This helps to narrow down the best choice of element(s) to be introduced into the weld by the GPA process. As a simple example, it is assumed that methane is the optimal choice, as likely would be the case for a low carbon steel which is not quite achieving the required hardness in the weld zone of a standard IKW.

Having chosen carbon, delivered in the form of methane gas as the element to be added to the weld, the main parameter to be selected is the concentration of methane in the argon shielding gas. It is practical to meter anywhere from a fraction of a percent up to 10% methane into the argon. Other parameters which will determine the final concentration of carbon in the weld zone are mainly the target induction temperature and the hold time at target temperature.

In the simplest example of two tubes being butt welded, the endface of each tube would be prepared for welding by having the endface squared off in a lathe operation and the sidewalls on the ID and OD cleaned back at least 2 cm back from the endface. These prepared parts can now be loaded into the IKW machine 120 and the preliminary pure argon purge commenced and should be run until the residual oxygen level in the welding chamber drops below 100 ppm.

At this point everything is ready for the weld cycle to begin, the first step being commencement of induction heating 125. Flow of the methane alloying gas can start simultaneously but it is understood that when using metallic particles suspended in carrier gas (e.g. argon), there would be advantages to delay the start of this flow until the tube endfaces have reached the hot forging temperature, to avoid unwanted accumulation of metal particles on horizontal surfaces of the tubes and/or welding chamber surfaces.

In the case of methane, it is acceptable to maintain flow for the entire duration of the soak time 130. But in the case of metal particles suspended in carrier gas, it may be desirable to reduce the duration of the flow to a short pulse which is shorter than the soak period of the induction heating cycle.

When sufficient concentration of alloying element has been deposited on the tube endfaces, the next phase of the IKW cycle can proceed 135. The induction coil retracts from between the tube ends and the gap is quickly closed and the lateral motion begins and continues for the prescribed amount of lateral viscoplastic shear, this being the kinetic phase of the weld.

At any point during the kinetic phase 140 the purge flow can be terminated and once the full kinetic cycle has been completed, the weld is finished. Cooling of the weld is typically so quick that the parts can be unclamped and unloaded as soon as the lateral motion ends.

In the case of hardness being the main objective of gas phase alloying, it is possible and practical to quickly perform nondestructive hardness tests on the weld 140 to determine whether the as-welded hardness is below the allowable maximum hardness. For example, in many oil and gas industry applications, the hardness must not exceed 22 on the Rockwell Hardness C-scale. So, if this criterion is not satisfied in the as-welded condition, the simplest remedy is to induction temper the weld 150 at a temperature comfortably below the Ac1 temperature.

A final decision is to determine if the specified minimum hardness has been achieved, whether with or without induction tempering 155. If yes, then all the foregoing parameters can be locked down and the production run of parts can be welded 160, 165. If not, then it is advisable to return to step 115 and refine the parameter settings.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

1. A method of alloying a weld in an induction-kinetic welding of metal parts together, said method comprising:
heating substantially planar portions of two metal parts with an induction heating coil in between the planar portions;
during at least a portion of the step of heating the planar portions, flowing a gas containing an alloying element precursor in proximity to the planar portions, wherein in a chemical reaction an alloying element alloys the planar portions;
retracting the induction heating coil from in between the planar portions;
forcing the planar portions into contact with each other and moving at least one of the two metal parts in a lateral motion to produce viscoplastic flow heating in a kinetic energy welding process, wherein the metal parts are welded together.

2. The method of alloying a weld in an induction-kinetic welding of metal parts together of claim 1, wherein the step of heating the planar portions lasts more than 10 seconds.

3. The method of alloying a weld in an induction-kinetic welding of metal parts together of claim 1, wherein the step of heating the planar portions lasts more than 10 seconds, wherein the planar portions reach a temperature of at least 1,000° C.

4. The method of alloying a weld in an induction-kinetic welding of metal parts together of claim 1, further comprising: during the step of heating the planar portions, maintaining a temperature of the planar portions of at least 700° C. for more than 5 seconds.

5. The method of alloying a weld in an induction-kinetic welding of metal parts together of claim 1, wherein the chemical reaction is defined by 3Fe+CH₄→Fe₃C+2H₂.

6. The method of alloying a weld in an induction-kinetic welding of metal parts together of claim 1, wherein the chemical reaction is defined by 6Fe+C₂H₄→2Fe₃C+2H₂.

7. The method of alloying a weld in an induction-kinetic welding of metal parts together of claim 1, wherein the chemical reaction is defined by 6Fe+C₂H₂→2Fe₃C+2H₂.

8. The method of alloying a weld in an induction-kinetic welding of metal parts together of claim 1, wherein the gas is flowed outwardly and substantially evenly across the planar portions in a direction away from an axis perpendicular to and running through a center of the planar portions.

9. The method of alloying a weld in an induction-kinetic welding of metal parts together of claim 1, wherein the planar portions are endfaces of two pipes, wherein the two pipes include a first pipe and a second pipe, wherein a first purge dam is disposed in the first pipe in proximity to the induction heating coil, wherein a second purge dam is disposed in the second pipe in proximity to the induction heating coil, wherein a gas diffuser is disposed in an assembly including the induction heating coil.

10. The method of alloying a weld in an induction-kinetic welding of metal parts together of claim 1, wherein the planar portions are endfaces of two pipes.

11. The method of alloying a weld in an induction-kinetic welding of metal parts together of claim 1, wherein the planar portions are endfaces of two pipes, wherein the two pipes include a first pipe and a second pipe, wherein a first purge dam is disposed in the first pipe in proximity to the induction heating coil, wherein a second purge dam is disposed in the second pipe in proximity to the induction heating coil, wherein a gas diffuser is disposed in the first purge dam.

12. The method of alloying a weld in an induction-kinetic welding of metal parts together of claim 1, wherein the gas is a carburizing gas, wherein a second gas is flowed in proximity to the planar portions, wherein the second gas contains an elemental transition metal, wherein the transition metal is deposited on the planar portions.

13. Welded pipes of the method of claim 11.

14. Welded metal parts of the method of claim 12.

15. The method of alloying a weld in an induction-kinetic welding of metal parts together of claim 1, wherein the steps of the method are performed at substantially atmospheric pressure.

16. A method of alloying a weld in an induction-kinetic welding of metal parts together, said method comprising:
heating substantially planar portions of two metal parts with an induction heating coil in between the planar portions;
during at least a portion of the step of heating the planar portions, flowing at least one of a reducing gas and then a gas containing an alloying element, or a combination of the reducing gas and the gas containing an alloying element in proximity to the planar portions, wherein the alloying element is deposited on the planar portions;
retracting the induction heating coil from in between the planar portions;
forcing the planar portions into contact with each other and moving at least one of the two metal parts in a lateral motion to produce viscoplastic flow heating in a kinetic energy welding process, wherein the metal parts arc welded together.

17. The method of alloying a weld in an induction-kinetic welding of metal parts together of claim 16, wherein the gas containing an alloying element comprises nanoparticles of the alloying element suspended in an inert gas.

18. A method of increasing the flowability and weldability of an induction-kinetic welding of metal parts together using an alloying element, said method comprising:
heating substantially planar portions of two metal parts with an induction heating coil in between the planar portions;
during at least a portion of the step of heating the planar portions, flowing a gas comprising about argon and methane in proximity to the planar portions;
retracting the induction heating coil from in between the planar portions;
forcing the planar portions into contact with each other and moving at least one of the two metal parts in a lateral motion to produce viscoplastic flow heating in a kinetic energy welding process, wherein the metal parts are welded together, wherein the methane gas has reacted with the planar portions, wherein during the kinetic energy welding process an instantaneous amplified shear rate is present before dilution of enriched carbon by shear accelerated diffusion occurs.

19. The method of increasing the flowability and weldability of an induction-kinetic welding of metal parts together using an alloying element of claim 18, wherein the gas is about 90% argon and 10% methane.

20. The method of increasing the flowability and weldability of an induction-kinetic welding of metal parts together using an alloying element of claim 18, wherein the carbon content on a surface of the planar portions increases to near 4.3% prior to the step of forcing the planar portions into contact with each other.

21. Welded metal parts of the method of claim 18.
